(19) United States
(12) Patent Application Publication
(10) Pub. No.: US 2005/0255282 A1
(43) Pub. Date: Nov. 17, 2005

(54) Optical recording medium

(75) Inventors: Narutoshi Fukuzawa, Tokyo (JP); Takashi Kikukawa, Tokyo (JP); Tatsuhiro Kobayashi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/117,340

(22) Filed: Apr. 29, 2005

(30) Foreign Application Priority Data
May 6, 2004 (JP) 2004-137029

(51) Int. Cl. B32B 3/02

(52) U.S. Cl. 428/64.4

(57) ABSTRACT

An optical recording medium that is constituted so that a laser beam is irradiated to record and reproduce data, the optical recording medium including a laminated body that is formed by sandwiching a second dielectric layer 6 between a recording layer 7 and a light absorption layer 5, the light absorption layer 5 containing “Ge”, “Sb and Ge”, “Sb and In”, or “Sb and Ga” as a main component.

### BACKGROUND OF THE INVENTION

The present invention relates to an optical recording medium, in more detail, to an optical recording medium that even when a length of a recording mark or a length of a blank region between adjacent recording marks is shorter than the limit of resolution, data constituted of a recording mark row that includes the recording mark and the blank region can be recorded and reproduced, and a recording capacity can be largely increased.

So far, as a recording medium that records digital data, optical recording mediums typical in CDs and DVDs have been widely used. However, recently, optical recording mediums having a larger capacity and a higher data transfer rate are being actively developed.

In such an optical recording medium, a wavelength λ of a laser beam that is used to record and reproduce data is made smaller and the numerical aperture NA of an objective lens is made larger to make a beam spot diameter of the laser beam smaller, and thereby a recording capacity of the optical recording medium is being increased.

In an optical recording medium, when a length of a recording mark recorded on the optical recording medium and a length between adjacent recording marks, that is, a length of a region where a recording mark is not formed (hereinafter, referred to as a blank region) is below the limit of resolution, data cannot be reproduced from the optical recording medium.

The limit of resolution is determined by a wavelength of the laser beam λ and the numerical aperture NA of an objective lens for focusing the laser beam. When a repetition frequency of the recording mark and the blank region, in other word, a spatial frequency, is 2NA/λ or more, data recorded in the recording mark and the blank region become impossible to read.

Accordingly, lengths of the recording mark and the blank region corresponding to a readable spatial frequency, respectively, become λ/4NA or more, and when a laser beam having a wavelength λ is focused by use of an objective lens having the numerical aperture NA on a surface of an optical recording medium, a recording mark and a blank region each having a length of λ/4NA become the shortest readable recording mark and blank region.

Thus, when data are reproduced, since there is the limit of resolution where data can be reproduced, there are limits on the lengths of the recording mark and the blank region that can be reproduced. Accordingly, even when a recording mark and a blank region having a length below the limit of resolution are formed to record data, the recorded data cannot be reproduced; accordingly, lengths of the recording mark and the blank region that can be formed when the data are recorded are necessarily restricted.

Accordingly, in order to increase the recording capacity of an optical recording medium, it is necessary that a wavelength λ of a laser beam that is used to reproduce data is shortened, or the numerical aperture NA of an objective lens is made larger to make the limit of resolution smaller, and thereby data made of a shorter recording mark and blank region are made readable.

However, there is a limit when a wavelength λ of a laser beam that is used to reproduce data is made shorter, or the numerical aperture NA of an objective lens is made larger. Accordingly, there is a limit when the limit of resolution is made smaller to increase the recording capacity of an optical recording medium.

### SUMMARY OF THE INVENTION

Accordingly, an object of the present invention is to provide an optical recording medium that even when a length of a recording mark and a length of a blank region between adjacent recording marks is below the limit of resolution, data constituted of a recording mark row including the recording marks and the blank regions can be recorded and reproduced and thereby the recording capacity can be largely increased.

Such an object of the invention can be achieved with an optical recording medium that is constituted so that a laser beam is irradiated and data are recorded and reproduced, the optical recording medium including a laminated body including a recording layer, a light absorption layer, and a dielectric layer interposed between the recording layer and the light absorption layer, the light absorption layer containing “Ge”, “Sb and Ge”, “Sb and In”, or “Sb and Ga” as a main component.

In the invention, the light absorption layer contains “Ge”, “Sb and Ge”, “Sb and In”, or “Sb and Ga” as a main component. In the invention, including Ge as a main component means that a content of Ge in the light absorption layer is 90 atomic percent or more, and including Sb and Ge as a main component means that a sum total of a content of Sb and a content of Ge in the light absorption layer is 90 atomic percent or more. Additionally, including Sb and In as a main component means that a sum total of a content of Sb and a content of In in the light absorption layer is 90 atomic percent or more, and including Sb and Ga as a main component means that a sum total of a content of Sb and a content of Ga in the light absorption layer is 90 atomic percent or more.

According to the present inventors' research, though the reason thereof is not necessarily clear, it is found that when a laminated body in which a recording layer and a light absorption layer are formed with at least a dielectric layer interposed therebetween is contained, and a light absorption layer contains as a main component “Ge”, “Sb and Ge”, “Sb and In”, or “Sb and Ga”, even when lengths of a recording mark and a blank region between adjacent recording marks that constitute a recording mark row formed on a recording layer are below the limit of resolution, data can be reproduced.

In the invention, the light absorption layer, when containing Sb and Ge as a main component, preferably contains Ge in the range of 50 to 85 atomic percent.

In the invention, the light absorption layer, when containing Sb and In as a main component, preferably contains In in the range of 5 to 45 atomic percent.

In the invention, the light absorption layer, when containing Sb and Ga as a main component, preferably contains Ga in the range of 10 to 20 atomic percent.

When the light absorption layer contains Sb and Ge as a main component and a content of Ge is in the range of 50 to 85 atomic percent, the reproducing sensitivity when data that are constituted of recording marks and blank regions below the limit of resolution are reproduced can be improved, and furthermore a reproduction signal high in the C/N ratio can be obtained.

When the light absorption layer contains Sb and In as a main component and a content of In is in the range of 5 to 45 atomic percent, the reproducing sensitivity when data that are constituted of recording marks and blank regions below the limit of resolution are reproduced can be improved, and furthermore a reproduction signal high in the C/N ratio can be obtained.

When the light absorption layer contains Sb and Ga as a main component and a content of Ga is in the range of 10 to 20 atomic percent, the reproducing sensitivity when data that are constituted of recording marks and blank regions below the limit of resolution are reproduced can be improved, and furthermore a reproduction signal high in the C/N ratio can be obtained.

In the invention, the light absorption layer preferably has a thickness in the range of 5 to 100 nm. When the thickness of the light absorption layer is less than 5 nm, the light absorption is too low. On the other hand, when it exceeds 100 nm, as will be described below, when a recording layer exhibits a change in volume, the light absorption layer unfavorably becomes difficult to deform.

In the invention, the recording layer is preferably constituted so that, when a laser beam set at a recording power is irradiated, a change in volume may be exhibited in a region where the laser beam is irradiated. A region where the recording layer underwent a change in volume, being different in the optical characteristics from a region where a change of volume is not exhibited, can be used as a recording mark.

The recording layer is preferably formed of an oxide of precious metal, and as an oxide of precious metal that is used to form the recording layer platinum oxide can be preferably used.

The platinum oxide is, different from other precious metal oxides, high in the decomposition temperature. Accordingly, when a laser beam set at a recording power is irradiated to form a recording mark, even when heat diffuses from a region where the laser beam is irradiated to the proximity, in a region other than a region where the laser beam is irradiated, the platinum oxide is inhibited from decomposing; accordingly, a desired region of the recording layer can be changed in a volume to form a recording mark.

Furthermore, also when a laser beam high in the reproduction power is irradiated to reproduce data, since platinum oxide is, in comparison with other precious metal oxides, higher in the decomposition temperature, there is no fear of platinum oxide being decomposed into platinum and oxygen. Accordingly, even when data recorded on the optical recording medium are repeatedly reproduced, neither a change in a shape of the recording mark is caused nor a new change in volume is caused in a region other than a region where the recording mark is formed; accordingly, the reproduction durability of the optical recording medium can be improved.

In the invention, furthermore, on a substrate, a reflective layer is preferably formed.

In the case of a reflective layer being formed on the substrate, when a laser beam set at the reproduction power Pr is irradiated, heat imparted by the laser beam can be diffused owing to the reflection layer from a portion where the laser beam is irradiated to the proximity. Accordingly, the optical recording medium can be assuredly inhibited from being overheated, resulting in inhibiting data recorded on the optical recording medium from deteriorating.

Furthermore, when a reflection layer is formed on a substrate, a laser beam reflected by a surface of the reflection layer and a laser beam reflected by a layer laminated on the reflection layer interfere each other to result in an increase in an amount of reflected light that constitutes a reproduction signal; accordingly, the C/N ratio of a reproduced signal can be also improved.

In the invention, a dielectric layer and a light absorption layer are preferably constituted so as to deform in accordance with a change of volume of the recording layer when a recording mark row is formed on the recording layer.

A region where a dielectric layer and a light absorption layer are deformed is different in the optical characteristics from that of a region where the dielectric layer and the light absorption layer are not deformed; accordingly, a reproduction signal more excellent in the signal characteristics can be obtained.

In the invention, the dielectric layer preferably contains a mixture of ZnS and SiO₂ as a main component. The dielectric layer that contains a mixture of ZnS and SiO₂ as a main component has high light transmittance to a recording and reproducing laser beam and, being relatively low in the hardness, when the recording layer exhibits a change in volume, can be readily deformed.

According to the present invention, an optical recording medium that even when a length of a recording mark and a length of a blank region between adjacent recording marks is below the limit of resolution, data constituted of a recording mark row including the recording marks and the blank regions can be recorded and reproduced and the recording capacity can be largely increased can be provided.

### BRIEF DESCRIPTION OF THE DRAWINGS

FIG. 1 is a schematic sectional view of an optical recording medium involving a preferable embodiment according to the present invention.

FIG. 2 is a schematic enlarged sectional view of a portion shown with A in FIG. 1.

FIG. 3A is a schematic partially enlarged sectional view of an optical recording medium before data are recorded, and

FIG. 3B being a schematic partially enlarged sectional view of an optical recording medium after data are recorded.

### DETAILED DESCRIPTION OF THE PREFERRED EMBODIMENTS

In what follows, preferable embodiments according to the invention will be detailed.

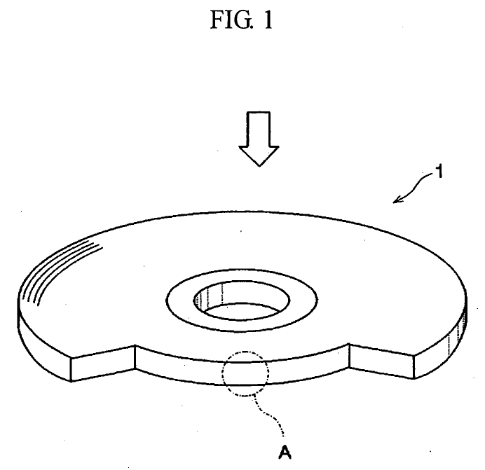

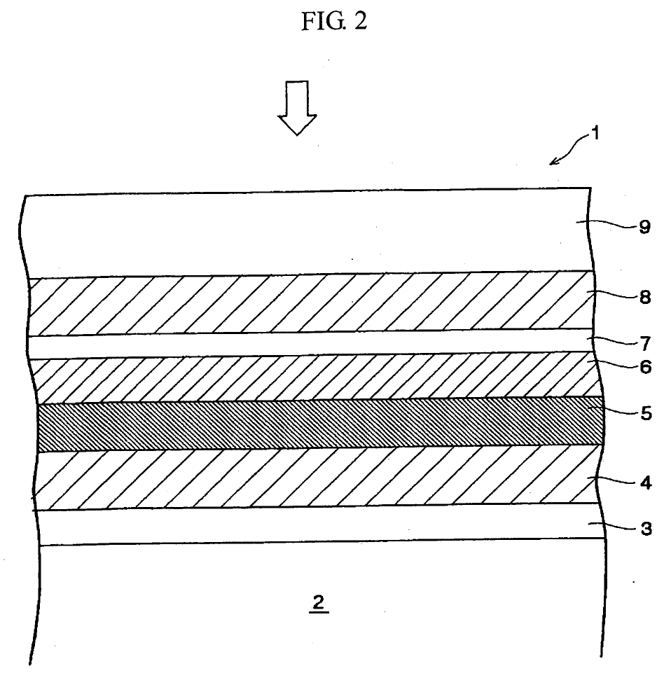

FIG. 1 is a schematic perspective view of an optical recording medium according to a preferable embodiment of the invention, and FIG. 2 is a schematic enlarged sectional view of a portion that is shown with A of a cross section along a track of the optical recording medium shown in FIG. 1.

As shown in FIG. 2, an optical recording medium 1 involving the present embodiment is provided with a supporting substrate 2, and, on the supporting substrate 2, a reflection layer 3, a third dielectric layer 4, a light absorption layer 5, a second dielectric layer 6, a recording layer 7, a first dielectric layer 8 and a light transmission layer 9 are laminated in this order.

In the embodiment, as shown in FIG. 2, the optical recording medium 1 is constituted so that a laser beam is irradiated from a side of the light transmission layer 9 to record data or reproduce the recorded data. The laser beam has a wavelength λ in the range of 390 to 420 nm and is focused by use of an objective lens having the numerical aperture NA in the range of 0.7 to 0.9 on the optical recording medium 1.

The supporting substrate 2 works as a support that secures the mechanical strength necessary for the optical recording medium 1.

Furthermore, the supporting substrate 2, on a surface thereof, from the proximity of a center portion thereof toward an external periphery thereof, is spirally provided with grooves (not shown in the drawing) and lands (not shown in the drawing).

The grooves and the lands work, when data are recorded on the recording layer 7 and when data recorded on the recording layer 7 are reproduced, as a guide track of the laser beam.

A material for forming the supporting substrate 2, as far as it can work as a supporting substrate of the optical recording medium 1, is not particularly restricted. For instance, a polycarbonate resin, and a polyolefin resin can be used.

A thickness of the supporting substrate 2 is not particularly restricted. However, from a viewpoint of the interchangeability with an optical recording medium compatible with a next-generation blue laser, the supporting substrate 2 is preferably formed with a thickness of substantially 1.1 mm.

As shown in FIG. 2, on a surface of the supporting substrate 2, the reflection layer 3 is formed.

The reflection layer 3 plays a role of reflecting a laser beam incident through the light transmission layer 9 and of letting exit again from the light transmission layer 9.

A material that forms the reflection layer 3, as far as it can reflect the laser beam, is not particularly restricted. One kind of element selected from a group consisting of Au, Ag, Cu, Pt, Al, Ti, Cr, Fe, Co, Ni, Mg, Zn, Ge and Si can be used.

A thickness of the reflection layer 3, though not particularly restricted, is preferably in the range of 5 to 200 nm.

As shown in FIG. 2, on a surface of the reflection layer 3, a third dielectric layer 4 is formed.

In the embodiment, the third dielectric layer 4 works so as to protect the supporting substrate 2 and the reflection layer 3 and furthermore works so as to physically and chemically protect the light absorption layer 5 formed thereon.

A dielectric material that forms the third dielectric layer 4 is not particularly restricted. For instance, the third dielectric layer 4 can be formed from a dielectric material of which main component is an oxide, a nitride, a sulfide, a fluoride or a combination thereof The third dielectric layer 4 is preferably formed of an oxide, a nitride, a sulfide, a fluoride or a combination thereof that contains at least one kind of metal selected from a group consisting of Si, Zn, Al, Ta, Ti, Co, Zr, Pb, Ag, Sn, Ca, Ce, V, Cu, Fe and Mg or a composite compound thereof, in particular, a mixture of ZnS and SiO₂ being preferable, a mixture of ZnS and SiO₂ mixed at a molar ratio of 80:20 being further preferable.

The third dielectric layer 4 can be formed by use of, for instance, a sputtering method.

A thickness of the third dielectric layer 4, though not particularly restricted, is preferably in the range of 10 to 140 nm.

As shown in FIG. 2, on a surface of the third dielectric layer 4, the light absorption layer 5 is formed.

In the embodiment, the light absorption layer 5 has a function of transferring heat generated by absorbing the laser beam when the laser beam set at a recording power Pw is irradiated on the optical recording medium 1 to the recording layer 7 described below.

In the embodiment, the light absorption layer 5 contains, as a main component, “Ge” “Sb and Ge”, “Sb and In” or “Sb and Ga”. In the present specification the containing Ge as a main component means that a content of Ge in the light absorption layer 5 is 90 atomic percent or more, and furthermore, the containing “Sb and Ge”, “Sb and In” or “Sb and Ga” as a main component means that a sum total of a content of Sb and a content of Ge, In or Ga is 90 atomic percent or more.

When the light absorption layer 5 contains Sb and Ge as a main component, Ge is preferably contained in the range of 50 to 85 atomic percent.

When the light absorption layer 5 contains Sb and In as a main component, In is preferably contained in the range of 5 to 45 atomic percent.

When the light absorption layer 5 contains Sb and Ga as a main component, Ga is preferably contained in the range of 10 to 20 atomic percent.

When the light absorption layer 5 contains Sb and Ge as a main component and Ge in the range of 50 to 85 atomic percent, when data constituted of a recording mark and a blank region that are smaller than the limit of resolution are reproduced, the reproduction sensitivity can be improved and a reproduction signal high in the C/N ratio can be obtained.

When the light absorption layer 5 contains Sb and In as a main component and In in the range of 5 to 45 atomic percent, when data constituted of a recording mark and a blank region that are smaller than the limit of resolution are reproduced, the reproduction sensitivity can be improved and a reproduction signal high in the C/N ratio can be obtained.

When the light absorption layer 5 contains Sb and Ga as a main component and Ga in the range of 10 to 20 atomic percent, when data constituted of a recording mark and a blank region that are smaller than the limit of resolution are reproduced, the reproduction sensitivity can be improved and a reproduction signal high in the C/N ratio can be obtained.

The light absorption layer 5 preferably has a thickness in the range of 5 to 100 nm. When the thickness of the light absorption layer 5 is less than 5 nm, the light absorption is too small, and, on the other hand, when it exceeds 100 nm, as will be described later, when a cavity is formed in the recording layer 7, the light absorption layer 7 becomes unfavorably difficult to deform.

The light absorption layer 5 can be formed by, for instance, a sputtering method.

As shown in FIG. 2, on a surface of the light absorption layer 5, the second dielectric layer 6 is formed.

In the embodiment, the second dielectric layer 6 has a function of physically and chemically protecting the first dielectric later 8 described below and the recording layer 7 described later.

In the embodiment, the second dielectric layer 6 contains a mixture of ZnS and SiO₂ as a main component. A dielectric layer containing a mixture of ZnS and SiO₂ as a main component has high light transmittance to a laser beam having a wavelength λ in the range of 390 to 420 nm and is relatively low in the hardness; accordingly, as will be described later, when a cavity is formed in the recording layer 7, the second dielectric layer 6 becomes favorably readily deformable.

The second dielectric layer 6 can be formed by use of, for instance, a sputtering method.

The second dielectric layer 6 is preferably formed so as to have a thickness in the range of 5 to 100 nm.

As shown in FIG. 2, on a surface of the second dielectric layer 6, the recording layer 7 is formed.

In the embodiment, the recording layer 7 is a layer thereon data are recorded and, when the data are recorded, on the recording layer 7, recording marks are formed.

In the embodiment, the recording layer 7 contains platinum oxide (PtOx) as a main component.

In the embodiment, also when a length of the recording mark and a length of a blank region between adjacent recording marks are equal to or less than the limit of resolution, in order to obtain a reproduction signal high in the C/N ratio, x preferably satisfies 1.0≦x<3.0.

A thickness of the recording layer 7 is preferably in the range of 2 to 20 nm and more preferably in the range of 4 to 20 nm. When the thickness of the recording layer 7 is less than 2 nm, in some cases, the recording layer 7 cannot be formed in a continuous film, and on the contrary thereto when it exceeds 20 nm, the recording layer 7 becomes difficult to deform.

The recording layer 7 can be formed by, for instance, a sputtering method.

As shown in FIG. 2, on a surface of the recording layer 7, the first dielectric layer 8 is formed.

In the embodiment, the first dielectric layer 8 works for physically and chemically protecting the recording layer 7.

The first dielectric layer 8 can be formed by use of a material same as that of the third dielectric layer 4, and similarly to the third dielectric layer 4 it can be formed by, for instance, a sputtering method.

As shown in FIG. 2, on a surface of the first dielectric layer 8, the light transmission layer 9 is formed.

The light transmission layer 9 is layer through which the laser beam progresses and a surface thereof forms an incident surface of the laser beam.

A material that forms the light transmission layer 9, as far as it is optically transparent, less in the optical absorption and reflection in the range of 390 to 420 nm that is a wavelength range of a laser beam that is used, and is small in the birefringence, is not particularly restricted. When the light transmission layer 9 is formed by use of a spin coat method or the like, a UV-curable resin, an EB-curable resin, and a thermosetting resin can be used to form the light transmission layer 9, and an active energy curable resin such as the UV-curable resin and EB-curable resin can be particularly preferably used to form the light transmission layer 9.

The light transmission layer 9 may be formed by adhering, on a surface of the first dielectric layer 8, by use of an adhesive, a sheet made of a light transmissive resin.

A thickness of the light transmission layer 9, when the light transmission layer 9 is formed by use of a spin coat method, is preferably in the range of 10 to 200 μm, and when a sheet made of a light transmissive resin is adhered by use of an adhesive on the surface of the first dielectric layer 8 to form a light transmission layer 9, is preferably in the range of 50 to 150,μm.

On thus constituted optical recording medium 1, according to a method mentioned below, data are recorded and the data are reproduced.

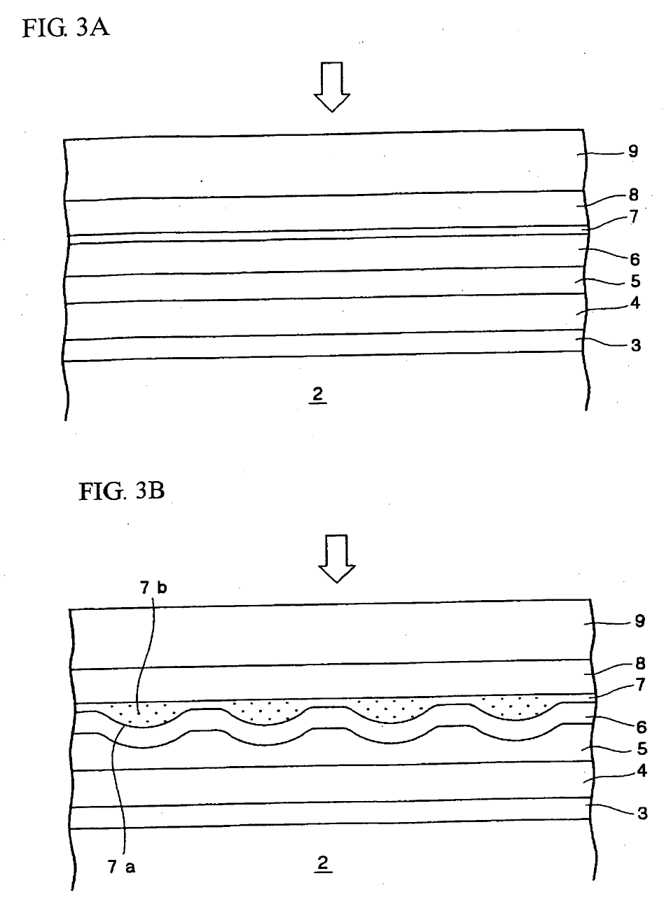

FIG. 3A is a partially enlarged schematic sectional view of an optical recording medium 1 before data are recorded and FIG. 3B is a partially enlarged schematic sectional view of the optical recording medium 1 after the data are recorded.

When data are recorded on the optical recording medium 1, through the light transmission layer 9, a laser beam is irradiated on the optical recording medium 1.

When a laser beam set at the recording power Pw is irradiated on the optical recording medium 1, a region of the light absorption layer 5 where the laser beam is irradiated is heated. Heat generated in the light absorption layer 5 is transmitted to the recording layer 7 to raise a temperature of the recording layer 7.

Platinum oxide contained in the recording layer 7 as a main component is high in the transparency to the laser beam; accordingly, even when the laser beam is irradiated, the recording layer 7 itself is difficult to be heated to a temperature equal to or more than the decomposition temperature of platinum oxide. However, in the embodiment, since the light absorption layer 5 is disposed, the light absorption layer 5 is heated, heat generated in the light absorption layer 5 is transmitted to the recording layer 7 to raise a temperature of the recording layer 7.

Thus, the recording layer 7 is heated to a temperature equal to or more than the decomposition temperature of platinum oxide, and thereby the platinum oxide contained in the recording layer 7 as a main component is decomposed into platinum and oxygen.

As a result, as shown in FIG. 3B, the platinum oxide is decomposed, owing to a generated oxygen gas a cavity 7a is formed in the recording layer 7 and fine particles 7b of platinum precipitate in the cavity 7a.

Simultaneously, as shown in FIG. 3B, owing to the pressure of an oxygen gas, together with the light absorption layer 5 and the second dielectric layer 6, the recording layer 7 is deformed.

Thus, a region where the cavity 7a is formed and the light absorption layer 5, the second dielectric layer 6 and the recording layer 7 are deformed is different in the optical characteristics from the other region; accordingly, owing to the region where the cavity 7a is formed and the light absorption layer 5, the second dielectric layer 6 and the recording layer 7 are deformed, a recording mark is formed.

Among thus formed recording marks and the blank regions between adjacent recording marks, ones having a length shorter than λ/4NA are contained; that is, a recording mark row below the limit of resolution is formed.

In the embodiment, since the recording layer 7 contains the platinum oxide high in the decomposition temperature as a main component, when a laser beam set at the recording power Pw is irradiated to form a recording mark, even when heat diffuses from a region where the laser beam is irradiated to the recording layer 7 in the proximity thereof, in a region other than that where the laser beam is irradiated, the platinum oxide is inhibited from decomposing; accordingly, in a desired region of the recording layer 7, a cavity 7a can be formed and thereby a recording mark can be formed.

Thus, data are recorded on the optical recording medium 1 and the data recorded on the optical recording medium 1 can be reproduced as shown below.

When a laser beam is irradiated on the optical recording medium 1, the optical recording medium 1 reflects the laser beam, the reflected laser beam is received by a photo-detector and converted into an electrical signal, and thereby the data recorded on the optical recording medium 1 are reproduced.

According to the inventors' study, though the reason is not clear, it is found that when a laser beam set at the recording power Pw is irradiated to a optical recording medium 1 provided with a recording layer 7 that contains platinum oxide as a main component and a light absorption layer 5 that contains “Ge”, “Sb and Ge”, “Sb and In” or “Sb and Ga” as a main component to form a cavity 7a in the recording layer 7 and precipitate platinum fine particles 7b in the cavity 7a to form a recording mark and record data, even when a length of the recording mark and a length of a blank region between adjacent recording marks that constitute a recording mark row are below the limit of resolution, the data can be reproduced.

Accordingly, according to the embodiment, even when a length of the recording mark and a length of a blank region between adjacent recording marks are below the limit of resolution, data made of a recording mark row including the recording marks and the blank regions can be recorded and reproduced, resulting in largely increasing the recording capacity.

Furthermore, in the embodiment, when a reflection layer 3 is formed on a supporting substrate 2 and a laser beam set at the reproduction power Pr is irradiated, heat imparted by the laser beam can be diffused owing to the reflection layer 3 from a place where the laser beam is irradiated to the surroundings. Accordingly, the optical recording medium 1 can be assuredly inhibited from being excessively heated and thereby the data recorded in the optical recording medium 1 can be inhibited from being deteriorated.

Furthermore, when a reflection layer 3 is formed on a supporting substrate 2, the laser beam reflected by a surface of the reflection layer 3 and the laser beam reflected by a layer laminated on the reflection layer 3 interfere each other to result in increasing an amount of reflected light that constitutes a reproduction signal; accordingly, the C/N ratio of the reproduction signal can be further improved.

### EXAMPLES

In what follows, in order to make advantages according to the invention clearer, examples will be illustrated.

### Example 1

A polycarbonate substrate having a thickness of 1.1 mm and a diameter of 120 mm was set on a sputtering device. On the polycarbonate substrate, by use of a Pt target, according to a sputtering method, a reflection layer having a thickness of 20 nm was formed.

In the next place, on a surface of the reflection layer, with a mixture of ZnS and SiO₂ as a target, according to a sputtering method, a third dielectric layer having a thickness of 100 nm was formed. As a mixture target of ZnS and SiO₂, one having a molar ratio of ZnS to SiO₂ of 80 to 20 was used.

Subsequently, on a surface of the third dielectric layer, by use of a Ge target, according to a sputtering method, a light absorption layer that contains Ge as a main component and has a thickness of 20 nm was formed.

Then, on a surface of the light absorption layer, with a target made of a mixture of ZnS and SiO₂, according to a sputtering method, a second dielectric layer having a thickness of 60 nm was formed. As a mixture target of ZnS and SiO₂, one having a molar ratio of ZnS to SiO₂ of 80 to 20 was used.

In the next place, on a surface of the second dielectric layer, by use of a mixture gas of Ar gas and oxygen gas as a sputtering gas and a Pt target, according to a sputtering method, a recording layer that contains platinum oxide as a main component and has a thickness of 4 nm was formed.

Then, on a surface of the recording layer, with a target made of a mixture of ZnS and SiO₂, according to a sputtering method, a first dielectric layer having a thickness of 75 nm was formed. As a mixture target of ZnS and SiO₂, one having a molar ratio of ZnS to SiO₂ of 80 to 20 was used.

Finally, on a surface of the first dielectric layer, a UV-curable acrylic resin was coated by means of a spin coat method, followed by irradiating UV light, and thereby a light transmission layer having a thickness of 100 μm was formed. Thus, a sample #1 was prepared.

In the next place, except for that with a Ge target and an Sb target, by means of a sputtering method, a light absorption layer was formed with a composition of Ge₄₈Sb₅₂ by atomic ratio and with a thickness of the first dielectric layer of 70 nm, similarly to the sample #1, a sample #2 was prepared.

Furthermore, except for that a composition of the light absorption layer was prepared so as to be Ge₆₀Sb₄₀ by atomic ratio, similarly to the sample #2, a sample #3 was prepared.

In the next place, except for that a composition of the light absorption layer was prepared so as to be Ge₇₅Sb₂₅ by atomic ratio, similarly to the sample #2, a sample #4 was prepared.

Furthermore, except for that a composition of the light absorption layer was prepared so as to be Ge₈₅Sb₁₅ by atomic ratio, similarly to the sample #2, a sample #5 was prepared.

### Example 2

A polycarbonate substrate having a thickness of 1.1 mm and a diameter of 120 mm was set on a sputtering device. On the polycarbonate substrate, by use of a Ag₉₈Pt₁Cu₁ target, according to a sputtering method, a reflection layer having a thickness of 40 nm was formed.

In the next place, on a surface of the reflection layer, with a mixture of ZnS and SiO₂ as a target, according to a sputtering method, a third dielectric layer having a thickness of 20 nm was formed. As a mixture target of ZnS and SiO₂, one having a molar ratio of ZnS to SiO₂ of 80 to 20 was used.

Subsequently, on a surface of the third dielectric layer, by use of Sn target and In target, according to a sputtering method, a light absorption layer that contains composition Sb₉₅In₅ and has a thickness of 20 nm was formed.

Then, on a surface of the light absorption layer, with a target made of a mixture of ZnS and SiO₂, according to a sputtering method, a second dielectric layer having a thickness of 60 nm was formed. As a mixture target of ZnS and SiO₂, one having a molar ratio of ZnS to SiO₂ of 80 to 20 was used.

In the next place, on a surface of the second dielectric layer, by use of a mixture gas of Ar gas and oxygen gas as a sputtering gas and a Pt target, according to a sputtering method, a recording layer that contains platinum oxide as a main component and has a thickness of 4 nm was formed.

Then, on a surface of the recording layer, with a target made of a mixture of ZnS and SiO₂, according to a sputtering method, a first dielectric layer having a thickness of 70 nm was formed. As a mixture target of ZnS and SiO₂, one having a molar ratio of ZnS to SiO₂ of 80 to 20 was used.

Finally, on a surface of the first dielectric layer, a UV-curable acrylic resin was coated by means of a spin coat method, followed by irradiating UV light, and thereby a light transmission layer having a thickness of 100 μm was formed. Thus, a sample #6 was prepared.

Furthermore, except for that a composition of the light absorption layer was prepared so as to be Sb₉₀In₁₀ by atomic ratio, similarly to the sample #6, a sample #7 was prepared.

Furthermore, except for that a composition of the light absorption layer was prepared so as to be Sb₈₅In₁₅ by atomic ratio, similarly to the sample #6, a sample #8 was prepared.

Furthermore, except for that a composition of the light absorption layer was prepared so as to be Sb₈₀In₂₀ by atomic ratio, similarly to the sample #6, a sample #9 was prepared.

Furthermore, except for that a composition of the light absorption layer was prepared so as to be Sb₇₅In₂₅ by atomic ratio, similarly to the sample #6, a sample #10 was prepared.

Furthermore, except for that a composition of the light absorption layer was prepared so as to be Sb₅₅In₄₅ by atomic ratio, similarly to the sample #6, a sample #11 was prepared.

Furthermore, except for that a composition of the light absorption layer was prepared so as to be Sb₄₀In₆₀ by atomic ratio, similarly to the sample #6, a sample #12 was prepared.

### Example 3

A polycarbonate substrate having a thickness of 1.1 mm and a diameter of 120 mm was set on a sputtering device. On the polycarbonate substrate, by use of a Ag₉₈Pd₁Cu₁ target, according to a sputtering method, a reflection layer having a thickness of 20 nm was formed.

In the next place, on a surface of the reflection layer, with a mixture of ZnS and SiO₂ as a target, according to a sputtering method, a third dielectric layer having a thickness of 20 nm was formed. As a mixture target of ZnS and SiO_{2,} one having a molar ratio of ZnS to SiO₂ of 80 to 20 was used.

Subsequently, on a surface of the third dielectric layer, by use of a Sb—Ga alloy target, according to a sputtering method, a light absorption layer that contains composition Sb₈₇Ga₁₃ and has a thickness of 10 nm was formed.

Then, on a surface of the light absorption layer, with a target made of a mixture of ZnS and SiO₂, according to a sputtering method, a second dielectric layer having a thickness of 60 nm was formed. As a mixture target of ZnS and SiO₂, one having a molar ratio of ZnS to SiO₂ of 80 to 20 was used.

In the next place, on a surface of the second dielectric layer, by use of a mixture gas of Ar gas and oxygen gas as a sputtering gas and a Pt target, according to a sputtering method, a recording layer that contains platinum oxide as a main component and has a thickness of 4 nm was formed.

Then, on a surface of the recording layer, with a target made of a mixture of ZnS and SiO₂, according to a sputtering method, a first dielectric layer having a thickness of 70 nm was formed. As a mixture target of ZnS and SiO₂, one having a molar ratio of ZnS to SiO₂ of 80 to 20 was used.

Finally, on a surface of the first dielectric layer, a UV-curable acrylic resin was coated by means of a spin coat method, followed by irradiating UV light, and thereby a light transmission layer having a thickness of 100 μm was formed. Thus, a sample #13 was prepared.

Furthermore, except for that a composition of the light absorption layer was prepared so as to be Sb₈₄Ga₁₆ by atomic ratio, similarly to the sample #13, a sample #14 was prepared.

Subsequently, sample #1 was set on an optical recording medium evaluation device “DDU1000” (product name) manufactured by Pulstec Industrial Co., Ltd. With a blue laser beam having a wavelength of 405 nm as a recording laser beam and an objective lens having the numerical aperture NA of 0.85, a laser beam was focused through a light transmission layer. Thus, under the conditions below, in a recording layer of the sample #1, a recording mark row made of recording marks of 75 nm and blank regions of 75 nm (hereinafter, referred to as 75 nm recording mark row) that are smaller than 112.5 nm that is the limit of resolution was formed to record data. When the data were recorded, the recording power Pw of the laser beam was set at 9.5 mW.

Linear Recording Velocity: 4.9 m/s.

Recording Method: On-Groove Recording.

Still furthermore, similarly to the sample #1, in each of the recording layers of the samples #2 through 5, a 75 nm recording mark row was sequentially formed to record data. When data were recorded in the recording layers of samples #2 through 5, the recording powers Pw of the laser beam were set at 7.0, 10.0, 10.0, and 9.5 mW, respectively, and the linear recording velocity was set at a constant value of 4.9 m/s.

After the data were recorded, with the same optical recording medium evaluation device, the data recorded on the #1 sample were reproduced and the C/N ratio of the reproduced signal was measured. At the reproduction of the data, the reproduction power Pr of the laser beam was set at 1.2 mW, and the linear reproduction velocity was set at 4.9 m/s.

In the next place, with the reproduction power Pr of the laser beam raising gradually in the range of 1.2 to 3.6 mW, sequentially, data recorded in the recording layer of the sample #1 were reproduced.

Furthermore, similarly to the sample #1, data recorded in the samples #2 through 5 were reproduced and the C/N ratios of the reproduced signals were measured. When the data recorded in the samples #2 through 5 were reproduced, the reproduction powers Pr of the laser beam, respectively, were varied in the range of 2.6 to 3.6 mW, 1.8 to 3.0 mW, 1.8 to 3.0 mW and 2.0 to 3.2 mW. Measurements are shown in Table 1.

TABLE 1

| Reproduction power Pr | C/N Ratio (dB) | | | | |
|---|---|---|---|---|---|
| (mW) | #1 | #2 | #3 | #4 | #5 |
| 1.2 | 0 | — | — | — | — |
| 1.4 | 2.9 | — | — | — | — |
| 1.6 | 6.3 | — | — | — | — |
| 1.8 | 6.2 | — | 0 | 0 | — |
| 2.0 | 6.7 | — | 3.0 | 5.1 | 0 |
| 2.2 | 7.7 | — | 10.0 | 9.9 | 19.4 |
| 2.4 | 28.9 | — | 27.0 | 26.6 | 25.5 |
| 2.6 | 30.9 | 0 | 25.0 | 24.0 | 24.3 |
| 2.8 | 29.2 | 17.7 | 24.9 | 24.9 | 24.8 |
| 3.0 | 27.7 | 24.5 | 23.0 | 22.2 | 21.6 |
| 3.2 | 29.6 | 25.6 | — | — | 21.8 |
| 3.4 | 32.2 | 21.0 | — | — | — |
| 3.6 | 35.0 | 21.4 | — | — | — |

As shown in Table 1, in the samples #1 through 5, the highest C/N ratios were 35.0 dB, 25.6 dB, 27.0 dB, 26.6 dB and 25.5 dB, respectively; that is, in all samples, the reproduction signal having the C/N ratio of 25 dB or more could be obtained.

Furthermore, as shown in Table 1, in each of the samples #3 through 5 where the light absorption layer contains Sb and Ge as a main component and a content of Ge is in the range of 50 to 85 atomic percent, the reproduction power Pr at which a reproduction signal having the highest C/N ratio could be obtained was 2.4 mW. On the other hand, in the sample #2 where the light absorption layer contains Sb and Ge as a main component but a content of Ge is less than 50 atomic percent, the reproduction power Pr at which a reproduction signal having the highest C/N ratio could be obtained was 3.2 mW. From these results, it is found that when the light absorption layer is formed so as to contain Sb and Ge as a main component and contain Ge in the range of 50 to 85 atomic percent, the reproduction sensitivity can be improved.

In the next place, the sample #1 was set on the foregoing optical recording medium evaluation device, followed by irradiating a laser beam set at the recording power Pw to form 50 nm, 75 nm and 112.5 nm recording mark rows that are smaller than the limit of resolution and 150 nm and 300 nm recording mark rows that are larger than the limit of resolution, respectively, to record data.

Furthermore, similarly to the sample #1, in the recording layer of each of the samples #2 through 5, recording mark rows from 50 nm to 300 nm were sequentially formed to record data.

When data were recorded on each of the recording layers of the samples #1 through 5, the linear recording velocity was set at 4.9 m/s, and the recording power Pw of the laser beam was set as shown in Table 2.

TABLE 2

| Length of recording | Pw (mW) | | | | |
|---|---|---|---|---|---|
| mark row | 50 nm | 75 nm | 112.5 nm | 150 nm | 300 nm |
| Sample #1 | 9.5 | 9.5 | 9.5 | 9.5 | 7.5 |
| Sample #2 | 7.0 | 7.0 | 7.0 | 7.0 | 7.0 |
| Sample #3 | 10.0 | 10.0 | 10.0 | 10.0 | 8.0 |
| Sample #4 | 10.0 | 10.0 | 10.0 | 10.0 | 8.0 |
| Sample #5 | 9.5 | 9.5 | 9.5 | 9.5 | 7.5 |

Subsequently, after the data were recorded, the samples #1 through 5 were set on the same optical recording medium evaluation device to sequentially reproduce the data recorded on the samples #1 through 5, and thereby the C/N of the reproduced signal was measured for each of the samples #1 through 5. When the data recorded on the sample #1 through 5 were reproduced, all samples were measured at the linear reproduction velocity of 4.9 m/s, and the reproduction power Pr of the laser beam was set as shown in Table 3.

Measurements are shown in Table 4.

TABLE 3

| Length of recording | Pr (mW) | | | | |
|---|---|---|---|---|---|
| mark row | 50 nm | 75 nm | 112.5 nm | 150 nm | 300 nm |
| Sample #1 | 2.6 | 2.6 | 2.6 | 2.6 | 2.6 |
| Sample #2 | 3.2 | 3.2 | 3.2 | 3.2 | 3.2 |
| Sample #3 | 2.6 | 2.6 | 2.6 | 2.6 | 2.6 |
| Sample #4 | 2.6 | 2.6 | 2.6 | 2.6 | 2.6 |
| Sample #5 | 2.8 | 2.8 | 2.8 | 2.8 | 2.8 |

TABLE 4

| Length of recording | C/N (dB) | | | | |
|---|---|---|---|---|---|
| mark row | 50 nm | 75 nm | 112.5 nm | 150 nm | 300 nm |
| Sample #1 | 6.8 | 30.9 | 42.0 | 52.8 | 57.4 |
| Sample #2 | 18.9 | 25.6 | 20.6 | 46.0 | 52.7 |
| Sample #3 | 18.0 | 25.0 | 24.0 | 50.0 | 59.0 |
| Sample #4 | 19.0 | 24.0 | 23.6 | 56.0 | 60.0 |
| Sample #5 | 17.4 | 24.8 | 27.1 | 55.0 | 56.0 |

As shown in Table 4, in all of the samples #1 through 5, it is acknowledged that when data constituted of a recording mark row larger than the limit of resolution are reproduced, the reproduction signals having very high C/N ratio such as 40 dB or more can be obtained. On the other hand, it is also acknowledged that when data that are constituted of a recording mark row smaller than the limit of resolution were reproduced, except for the smallest 50 nm recording mark row, the reproduction signal having the C/N ratio equal to or more than 20 dB could be obtained.

Furthermore, when focusing attention on the C/N ratio of the reproduction signal when data constituted of the 112.5 nm recording mark row were reproduced, in the samples #2 through 5, the C/N ratios of the reproduction signals were 30 dB or less. On the other hand, it is acknowledged that in the sample #1, the reproduction signal having the very high C/N ratio such as 40 dB or more could be obtained.

Subsequently, sample #6 was set on an optical recording medium evaluation device “DDU1000” (product name) manufactured by Pulstec Industrial Co., Ltd. With a blue laser beam having a wavelength of 405 nm as a recording laser beam and an objective lens having the numerical aperture NA of 0.85, a laser beam was focused through a light transmission layer. Thus, under the conditions below, in a recording layer of the sample #6, a recording mark row made of recording marks of 75 nm and blank regions of 75 nm (hereinafter, referred to as 75 nm recording mark row) that are smaller than 112.5 nm that is the limit of resolution was formed to record data. When the data were recorded, the recording power Pw of the laser beam was set at 10.0 mW.

Linear Recording Velocity: 4.9 m/s.

Recording Method: On-Groove Recording.

Still furthermore, similarly to the sample #6, in each of the recording layers of the samples #7 through #12, a 75 nm recording mark row was sequentially formed to record data. When data were recorded in the recording layers of samples #7 through #12, the recording powers Pw of the laser beam were set at 8.0, 11.0, 9.0, 11.0, 10.0 and 10.0 mW, respectively, and the linear recording velocity was set at a constant value of 4.9 m/s.

After the data were recorded, with the same optical recording medium evaluation device, the data recorded on the #6 sample were reproduced and the C/N ratio of the reproduced signal was measured. At the reproduction of the data, the reproduction power Pr of the laser beam was set at 3.2 mW, and the linear reproduction velocity was set at 4.9 m/s.

In the next place, with the reproduction power Pr of the laser beam raising gradually in the range of 2.6 to 3.2 mW, sequentially, data recorded in the recording layer of the sample #6 were reproduced.

Furthermore, similarly to the sample #6, data recorded in the samples #7 through #12 were reproduced and the C/N ratios of the reproduced signals were measured. When the data recorded in the samples #7 through #12 were reproduced, the reproduction powers Pr of the laser beam, respectively, were varied in the range of 2.2 to 3.0 mW, 1.2 to 3.0 mW, 1.6 to 3.0 mW, 1.8 to 3.2 mW, 2.4 to 3.2 mW, and 2.6 to 3.4 mW. Measurements are shown in Table 5.

TABLE 5

| Reproduction | C/N Ratio (dB) | | | | | | |
|---|---|---|---|---|---|---|---|
| power Pr (mW) | #6 | #7 | #8 | #9 | #10 | #11 | #12 |
| 1.2 | — | — | 0.0 | — | — | — | — |
| 1.4 | — | — | 15.9 | — | — | — | — |
| 1.6 | — | — | 24.1 | 0.0 | — | — | — |
| 1.8 | — | — | 37.9 | 6.0 | 0.0 | — | — |
| 2.0 | — | — | 42.4 | 15.4 | 11.2 | — | — |
| 2.2 | — | 0.0 | 43.8 | 31.6 | 17.2 | — | — |
| 2.4 | — | 14.9 | 45.4 | 37.0 | 28.5 | 0.0 | — |
| 2.6 | 0.0 | 30.2 | 46.5 | 38.3 | 32.9 | 3.6 | 0.0 |
| 2.8 | 2.5 | 37.3 | 45.5 | 41.6 | 37.0 | 23.2 | 11.0 |
| 3.0 | 24.9 | 39.7 | 45.3 | 42.2 | 38.7 | 24.8 | 16.5 |
| 3.2 | 25.0 | — | — | — | 41.0 | 25.2 | 19.2 |
| 3.4 | — | — | — | — | — | — | 17.5 |

As shown in Table 5, in the samples #6 through #12, the highest C/N ratios were 25.0 dB, 39.4 dB, 46.5 dB, 42.2 dB, 41.0 dB, 25.2 dB, and 19.2, respectively; that is, in all samples containing In in the range of 5 to 45 atomic percent, excepting the example #12, the reproduction signal having the C/N ratio of 25 dB or more could be obtained.

Furthermore, as shown in Table 5, in each of the samples #7 through #9 where the light absorption layer contains Sb and In as a main component and a content of In is in the range of 10 to 20 atomic percent, the reproduction power Pr at which a reproduction signal having the highest C/N ratio could be obtained was 3.0 mW. From these results, it is found that when the light absorption layer is formed so as to contain Sb and In as a main component and contain In in the range of 10 to 20 atomic percent, the reproduction sensitivity can be improved.

In the next place, the sample #6 was set on the foregoing optical recording medium evaluation device, followed by irradiating a laser beam set at the recording power Pw to form 50 nm, 75 nm and 112.5 nm recording mark rows that are smaller than the limit of resolution and 150 nm and 300 nm recording mark rows that are larger than the limit of resolution, respectively, to record data.

Furthermore, similarly to the sample #6, in the recording layer of each of the samples #7 through #12, recording mark rows from 50 nm to 300 nm were sequentially formed to record data.

When data were recorded on each of the recording layers of the samples #6 through #12, the linear recording velocity was set at 4.9 m/s, and the recording power Pw of the laser beam was set as shown in Table 6.

TABLE 6

| Length of recording | Pw (mW) | | | | |
|---|---|---|---|---|---|
| mark row | 50 nm | 75 nm | 112.5 nm | 150 nm | 300 nm |
| Sample #6 | 10.0 | 10.0 | 10.0 | 10.0 | 8.0 |
| Sample #7 | 8.0 | 8.0 | 8.0 | 8.0 | 6.0 |
| Sample #8 | 11.0 | 11.0 | 11.0 | 11.0 | 9.0 |
| Sample #9 | 9.0 | 9.0 | 9.0 | 9.0 | 7.0 |
| Sample #10 | 11.0 | 11.0 | 11.0 | 11.0 | 9.0 |
| Sample #11 | 10.0 | 10.0 | 10.0 | 10.0 | 8.0 |
| Sample #12 | 10.0 | 10.0 | 10.0 | 10.0 | 8.0 |

Subsequently, after the data were recorded, the samples #6 through 12 were set on the same optical recording medium evaluation device to sequentially reproduce the data recorded on the samples #6 through 12, and thereby the C/N of the reproduced signal was measured for each of the samples #6 through 12. When the data recorded on the sample #6 through 12 were reproduced, all samples were measured at the linear reproduction velocity of 4.9 m/s, and the reproduction power Pr of the laser beam was set as shown in Table 7.

Measurements are Shown in Table 8.

TABLE 7

| Length of recording | Pr (mW) | | | | |
|---|---|---|---|---|---|
| mark row | 50 nm | 75 nm | 112.5 nm | 150 nm | 300 nm |
| Sample #6 | 3.2 | 3.2 | 3.2 | 3.2 | 3.2 |
| Sample #7 | 3.0 | 3.0 | 3.0 | 3.0 | 3.0 |
| Sample #8 | 2.6 | 2.6 | 2.6 | 2.6 | 2.6 |
| Sample #9 | 3.0 | 3.0 | 3.0 | 3.0 | 3.0 |
| Sample #10 | 3.2 | 3.2 | 3.2 | 3.2 | 3.2 |
| Sample #11 | 3.2 | 3.2 | 3.2 | 3.2 | 3.2 |
| Sample #12 | 3.2 | 3.2 | 3.2 | 3.2 | 3.2 |

TABLE 8

| Length of recording | C/N (dB) | | | | |
|---|---|---|---|---|---|
| mark row | 50 nm | 75 nm | 112.5 nm | 150 nm | 300 nm |
| Sample #6 | 18.0 | 25.0 | 41.3 | 43.5 | 55.2 |
| Sample #7 | 25.2 | 39.7 | 41.2 | 46.8 | 56.8 |
| Sample #8 | 39.2 | 46.5 | 44.5 | 48.5 | 54.5 |
| Sample #9 | 26.4 | 42.2 | 41.3 | 50.2 | 52.3 |
| Sample #10 | 25.8 | 41.0 | 40.2 | 49.0 | 55.6 |
| Sample #11 | 18.2 | 25.2 | 43.2 | 44.2 | 54.2 |
| Sample #12 | 5.2 | 19.2 | 42.2 | 43.2 | 52.1 |

As shown in Table 8, in all of the samples #6 through 12, it is acknowledged that when data constituted of a recording mark row larger than the limit of resolution are reproduced, the reproduction signals having very high C/N ratio such as 40 dB or more can be obtained. On the other hand, it is also acknowledged that when data that are constituted of a recording mark row smaller than the limit of resolution were reproduced, except for the smallest 50 nm recording mark row and the case of #12, the reproduction signal having the C/N ratio equal to or more than 20 dB could be obtained.

Subsequently, samples #13 and #14 were set on an optical recording medium evaluation device “DDU1000” (product name) manufactured by Pulstec Industrial Co., Ltd. With a blue laser beam having a wavelength of 405 nm as a recording laser beam and an objective lens having the numerical aperture NA of 0.85, a laser beam was focused through a light transmission layer. Thus, under the conditions below, in a recording layer of the samples #13 and #14, a recording mark row made of recording marks of 75 nm and blank regions of 75 nm (hereinafter, referred to as 75 nm recording mark row) that are smaller than 112.5 nm that is the limit of resolution was formed to record data. When the data were recorded, the recording power Pw of the laser beam was set at 9.0 mW.

Linear Recording Velocity: 4.9 m/s.

Recording Method: On-Groove Recording.

After the data were recorded, with the same optical recording medium evaluation device, the data recorded on the #13 and 14 samples were reproduced and the C/N ratio of the reproduced signal was measured. At the reproduction of the data, the reproduction power Pr of the laser beam was set at 3.2 mW, and the linear reproduction velocity was set at 4.9 m/s.

In the next place, with the reproduction power Pr of the laser beam raising gradually in the range of 2.2 to 3.4 mW, sequentially, data recorded in the recording layer of the samples #13 and #14 were reproduced. Measurements are shown in Table 9.

TABLE 9

| | |
|---|---|
| Reproduction power Pr | C/N Ratio (dB) |

| (mW) | Sample #13 | Sample #14 |
|---|---|---|
| 2.2 | 0.0 | 0.0 |
| 2.4 | 11.2 | 9.5 |
| 2.6 | 23.9 | 22.5 |
| 2.8 | 32.5 | 34.5 |
| 3.0 | 35.1 | 37.8 |
| 3.2 | 39.3 | 40.1 |
| 3.4 | 38.7 | 39.7 |

As shown in Table 9, in the samples #13 and #14, the highest C/N ratios were 39.3 dB and 40.1 dB, respectively; that is, in all samples containing Ga in a range 10 to 20 atomic percent, the reproduction signal having the C/N ratio of 25 dB or more could be obtained.

In the next place, the samples #13 and 14 were set on the foregoing optical recording medium evaluation device, followed by irradiating a laser beam set at the recording power Pw to form 50 nm, 75 nm and 112.5 nm recording mark rows that are smaller than the limit of resolution and 150 nm and 300 nm recording mark rows that are larger than the limit of resolution, respectively, to record data.

When data were recorded on each of the recording layers of the samples #13 and #14, the linear recording velocity was set at 4.9 m/s, and the recording power Pw of the laser beam was set as shown in Table 10.

TABLE 10

| Length of recording | Pw (mW) | | | | |
|---|---|---|---|---|---|
| mark row | 50 nm | 75 nm | 112.5 nm | 150 nm | 300 nm |
| Sample #13 | 9.0 | 9.0 | 9.0 | 9.0 | 7.0 |
| Sample #14 | 9.0 | 9.0 | 9.0 | 9.0 | 7.0 |

Subsequently, after the data were recorded, the samples #13 and #14 were set on the same optical recording medium evaluation device to sequentially reproduce the data recorded on the samples #13 and #14, and thereby the C/N of the reproduced signal was measured for each of the samples #13 and #14. When the data recorded on the sample #13 and 14 were reproduced, all samples were measured at the linear reproduction velocity of 4.9 m/s, and the reproduction power Pr of the laser beam was set as shown in Table 11.

Measurements are shown in Table 12.

TABLE 11

| Length of recording | Pr (mW) | | | | |
|---|---|---|---|---|---|
| mark row | 50 nm | 75 nm | 112.5 nm | 150 nm | 300 nm |
| Sample #13 | 3.2 | 3.2 | 3.2 | 3.2 | 3.2 |
| Sample #14 | 3.2 | 3.2 | 3.2 | 3.2 | 3.2 |

TABLE 12

| Length of | | | | | |
|---|---|---|---|---|---|
| recording mark | C/N (dB) | | | | |
| row | 50 nm | 75 nm | 112.5 nm | 150 nm | 300 nm |
| Sample #13 | 34.9 | 39.3 | 45.1 | 46.5 | 52.5 |
| Sample #14 | 35.2 | 40.1 | 44.6 | 46.8 | 53.2 |

As shown in Table 12, in both of the samples #13 and #14, it is acknowledged that when data constituted of a recording mark row larger than the limit of resolution are reproduced, the reproduction signals having very high C/N ratio such as 40 dB or more can be obtained. On the other hand, it is also acknowledged that when data that are constituted of a recording mark row smaller than the limit of resolution were reproduced, except for the smallest 50 nm recording mark row, the reproduction signal having the C/N ratio equal to or more than 20 dB could be obtained.

The present invention, without restricting to the foregoing embodiments and examples, can be variously modified within the range of the present invention, and it goes without saying that these are also included in the range of the present invention.

The optical recording medium 1 involving the embodiment shown in, for instance, FIGS. 1 and 2 is constituted so that it may include a supporting substrate 2, on the supporting substrate 2 a reflection layer 3, a third dielectric layer 4, a light absorption layer 5, a second dielectric layer 6, a recording layer 7, a first dielectric layer 8 and a light transmission layer 9 are laminated in this order, and from a side of the light transmission layer 9 a laser beam is irradiated. However, the present invention is not restricted thereto. For instance, the invention can be applied also to a DVD type optical recording medium that is constituted so that it may include a light-transmitting substrate that allows a laser beam to transmit, on the light-transmitting substrate a first dielectric layer 8, a recording layer 7, a second dielectric layer 6, a light absorption layer 5, and a third dielectric layer 4 are laminated in this order, and from a side of the light transmitting substrate a laser beam is irradiated.

Furthermore, in the optical recording medium 1 involving the embodiment shown in FIGS. 1 and 2, the recording layer 7 is formed so as to include a precious metal oxide as a main component. However, the invention is not restricted thereto. For instance, a recording layer may be formed so as to include an organic dye as a main component. In this case, as the organic dye that forms a recording layer, one that has the absorptivity to the recording laser beam and the decomposition temperature of 300 degrees centigrade or more is preferable. Furthermore, the recording layer may be formed so as to include in place of the organic dye, a metal or semi-metal low in the thermal conductivity. In this case, as the metal or semi-metal that is contained in the recording layer as a main component, a metal or semi-metal having the thermal conductivity of 2.0 W/(cm·K) or less can be preferably used.

Still furthermore, in the optical recording medium 1 involving the embodiment shown in FIGS. 1 and 2, from a light incident surface of the laser beam, the recording layer 7, the second dielectric layer 6 and the light absorption layer 5 are sequentially stacked. However, the invention is not restricted thereto. For instance, from a side opposite to a light incident surface of the laser beam, the recording layer 7, the second dielectric layer 6 and the light absorption layer 5 may be sequentially stacked, alternatively, from a light incident surface of the laser beam, a light absorption layer, a dielectric layer, a recording layer, a dielectric layer and a light absorption layer may be sequentially stacked. That is, in the invention, an optical recording medium has only to include a laminated body that is formed with at least a dielectric layer interposed between a recording layer and a light absorption layer.

This application is based upon and claims the benefit of priority of Japanese Patent Application No. 2004-137029 filed on May 6, 2004, the contents of which are incorporated herein by reference in its entirety.

1. An optical recording medium constituted so that a laser beam is irradiated to record and reproduce data, comprising:
a laminated body including a recording layer, a light absorption layer, and a dielectric layer interposed between the recording layer and the light absorption layer,
wherein the light absorption layer contains “Ge”, “Sb and Ge”, “Sb and In”, or “Sb and Ga” as a primary component.

2. The optical recording medium according to claim 1, wherein the light absorption layer contains Ge 90 atomic percent or more.

3. The optical recording medium according to claim 1, wherein the light absorption layer contains Ge and Sb in that a sum total of a content of Sb and a content of Ge is 90 atomic percent or more.

4. The optical recording medium according to claim 3, wherein the light absorption layer contains Sb and Ge as a primary component, the Ge being contained by 50 to 85 atomic percent.

5. The optical recording medium according to claim 1, wherein the light absorption layer contains Sb and In in that a sum total of a content of Sb and a content of In is 90 atomic percent or more.

6. The optical recording medium according to claim 5, wherein the light absorption layer contains Sb and In as a primary component, the In being contained by 5 to 45 atomic percent.

7. The optical recording medium according to claim 1, wherein the light absorption layer contains Sb and Ga in that a sum total of a content of Sb and a content of Ga is 90 atomic percent or more.

8. The optical recording medium according to claim 7, wherein the light absorption layer contains Sb and Ga as a primary component, the Ga being contained by 10 to 20 atomic percent.

9. The optical recording medium according to claim 1, wherein the light absorption layer has a thickness in the range of 5 to 100 nm.

10. The optical recording medium according to claim 1, wherein the recording layer is formed of an oxide of precious metal.

11. The optical recording medium according to claim 9, wherein the recording layer is formed of platinum oxide.

12. The optical recording medium according to claim 1, wherein the laminated body is formed on a reflective layer.

13. The optical recording medium according to claim 1, wherein a dielectric layer and a light absorption layer are constituted so as to deform in accordance with a change of volume of the recording layer when a recording mark row is formed on the recording layer.

14. The optical recording medium according to claim 1, wherein the dielectric layer contains a mixture of ZnS and SiO₂ as a main component.
